(19) United States
(12) Patent Application Publication
(10) Pub. No.: US 2008/0033711 A1
(43) Pub. Date: Feb. 7, 2008

(54) METHOD AND SYSTEM FOR TESTING TRANSLATABILITY OF NON-TEXTUAL RESOURCES

(76) Inventors: STEVEN E. ATKIN, Wesley Chapel, FL (US); NATHAN V. BAK, Portland, OR (US); DALE M. SCHULTZ, Chelmsford, MA (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/462,734

(22) Filed: Aug. 7, 2006

(51) Int. Cl. G06F 17/28

(52) U.S. Cl. 704/2

(57) ABSTRACT

The present invention is a method and system for testing translatability of non-textual resources. A method of the present invention for testing translatability of non-textual resources may include identifying and locating non-textual resources. The method of the present invention may further include modifying non-textual resources. Modification of non-textual resources may include the creation of a pseudo-translation copy of the non-textual resource. After modification of the non-textual resource, the modified non-textual resource may be tested to determine if they operate as expected.

### FIELD OF THE INVENTION

The present invention generally relates to the field of multi-language software development, and more particularly to a method and system for testing translatability of non-textual resources.

### BACKGROUND OF THE INVENTION

As computers have become more prevalent, it has become desirable for software developers to market their products to those people who do not speak the native language of the software developers. For example, software developed in the English language may be made available to those persons, both in the United States and in the rest of the world, that do not speak English. Accordingly, many software applications that are developed in English are later translated for use by non-English speakers.

When software has been translated, a global verification test, part of a product functional verification test, may address international translation issues. A global verification test determines whether a product may operate in a different environment and after translation. The global verification test may also determine if a product is ready for world-wide distribution.

Currently, a global verification test verifies textual resources of a product but fails to verify non-textual resources, such as icons, images and sound files. Non-textual resources are becoming increasingly prevalent in many software applications and products. When a translatability problem is not identified during a global verification test, resolution of a translatability problem at translation time is more expensive and difficult. Therefore, it would be desirable to create a method and a system for testing translatability of non-textual resources.

### SUMMARY OF THE INVENTION

Accordingly, the present invention is a method and system for testing translatability of non-textual resources of applications. In one embodiment of the invention, a method for testing translatability of non-textual resources may include identifying and locating non-textual resources. The method of the present invention may further include modifying non-textual resources. Modification of non-textual resources may include the creation of a pseudo-translation copy of the non-textual resource. After modification of the non-textual resource, the modified non-textual resource may be tested to determine if they operate as expected.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method for testing translatability of non-textual resources in accordance with an embodiment of the present invention;

FIG. 2 is flow diagram illustrating a method for testing translatability of non-textual resources in accordance with an alternative embodiment of the present invention;

FIG. 3A is an illustration of a display including an icon representing a first file and a second icon representing a second file;

FIG. 3B is an illustration of a pseudo-translation display whereby an icon which includes a marker through the icon to identify a pseudo-translated graphic representing a pseudo translated file; and

FIG. 4 is an illustration of a processing system in accordance with an embodiment of the present invention.

### DETAILED DESCRIPTION OF THE INVENTION

Reference will now be made in detail to the presently preferred embodiments of the invention, examples of which are illustrated in the accompanying drawings.

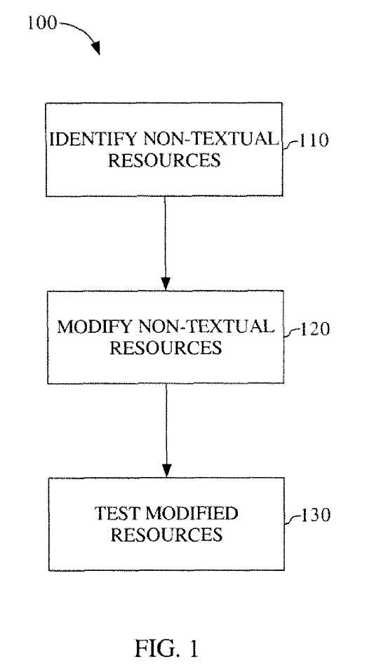

Referring generally to FIGS. 1-4, embodiments of a method and system for testing translatability of non-textual resources are shown. Applications, such as web pages, may include text and non-textual resources which may be employed in a variety of languages. In order to determine the translatability of an application, the method of the present invention may identify and locate non-textual resources. The method of the present invention may further include modifying non-textual resources. Modification of non-textual resources may include the creation of a pseudo-translation copy of the non-textual resource. After modification of the non-textual resource, the modified non-textual resource may be tested to determine if they operate as expected.

Referring specifically to FIG. 1, a flow diagram illustrating a method 100 for testing translatability of non-textual resources in accordance with an embodiment of the present invention is shown. It is contemplated that non-textual resources may include icons, images, sound files and the like. Method 100 may begin upon the identification of non-textual resources 110. It is contemplated that many non-textual resources may exist as files in particular file formats. For example, non-textual resources such as icons, images and sound files may be present within particular file formats such as joint photographs expert group (JPEG), waveform audio format (WAV), graphics interchange format (GIF), bitmap format (BMP) and the like. Location and identification of non-textual resources may be implemented by a search of files associated with an application under test by identifying files with particular file name extensions. For example, identification of non-textual resources may include a search of files with file name extensions such as jpg, wav, gif and bmp which are associated with file formats joint photographs expert group (JPEG), waveform audio format (WAV), graphics interchange format (GIF) and bitmap format (BMP) respectively.

Method 100 of the present invention may include modification of the identified non-textual resources 120. Modification of non-textual resources may include the creation of a pseudo-translation copy of the non-textual resource. The pseudo-translation copy of the non-textual resource may be a duplicate copy of the non-textual resource. The pseudo-translation copy is the same as the original except the file name is changed to match the translated language that is being tested. The pseudo-translation copy may be made available for a test by re-naming files. For example, an English audio file called welcome.wav may be stored as welcome_de.wav when translated into German. Alternatively, a pseudo-translation copy may be placed in a separate folder storing one or more translated resources for the same language whereby each language may have its own folder that mirrors original files. It is contemplated that method 100 may operate with other types of methods of providing translated resources. Method 100 may further include testing of the modified resources 130. Testing of the modified resources may determine whether a full translation of the modified resources is possible. If the testing of the modified resources is successful then it is safe for the product to be fully translated. Testing of the modified resources may allow detection of any translatability errors. An application may be operable to function and may utilize the pseudo-translation copy in the same manner as the original language resources are utilized. Any problems which may be detected may be translatability issues which may be investigated and resolved. If during testing errors are uncovered the product is not ready to be translated. Such errors may indicate that the product assumes it will be operating in an English language environment e.g, English version of Microsoft Windows.

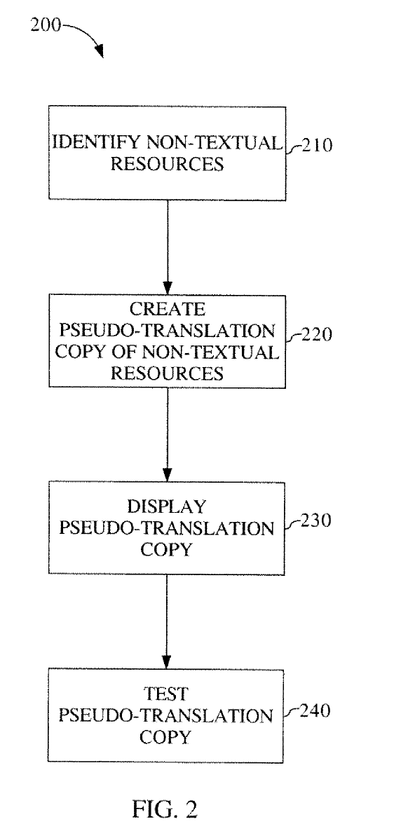

Referring to FIG. 2, a flow diagram illustrating a method 200 for testing translatability of non-textual resources in accordance with an alternative embodiment of the present invention is shown. Method 200 may begin by identifying non-textual resources within an application 210. A pseudo-translation copy of non-textual resources may be created 220.

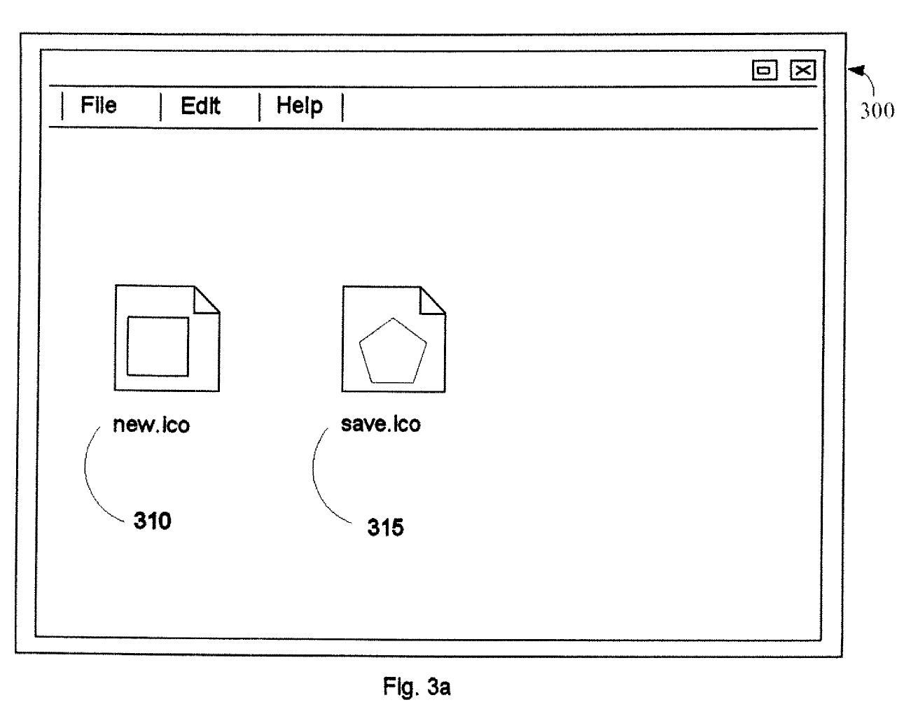

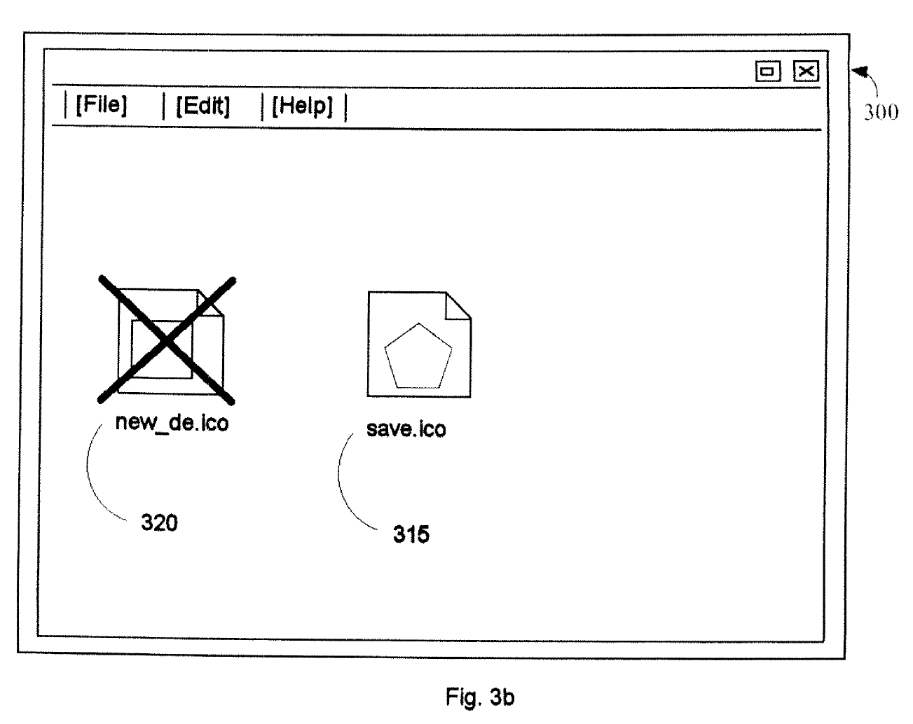

After creation of pseudo-translation copies, visual non-textual resources may be displayed. Referring to FIG. 3A, an illustration of a display 300 including an icon representing a first file 310 and a second icon representing a second file 315 is shown. Referring to FIG. 3B, an illustration of a pseudo-translation display 300 whereby an icon which includes a marker, such as an “X” through the icon to identify a pseudo-translated graphic representing a pseudo-translated file 320 is shown. Pseudo-translation display 300 also includes a second icon representing a second file 315 that has not been pseudo-translated. Second file 315 indicates a potential translatability problem in that the file was not pseudo-translated. File 320 may have a modified file name which may indicate the language translation of the file. For example, file 320 represents a pseudo-translation copy which includes “de” in the file name which may indicate the pseudo-translation copy has been translated to German. It is contemplated that any file name may be employed to indicate the language translation of the pseudo-translation copy. Advantageously, the use of a marker may help distinguish the original file from the pseudo-translation copy for a tester. Alternatively, original resources may be deleted to ensure that a tester knows that a re-named resource represents the pseudo-translation copy. Additionally, audio and video clips may include a canned clip or sound byte prepended to the original audio or video clip. It is contemplated that audio and video clips may be extended in length to ensure that the translated resource may be longer than the original resource without exceeding storage space.

Referring once again to FIG. 2, method 200 may further include testing of the pseudo-translation copy 230. An application may be operable to function and may utilize the pseudo-translation copy in the same manner as the original language resources are utilized. When the application functionality is run in a pseudo-translation mode, a resource which does not include a pseudo indicator, such as a sound byte, may indicate a hard coded resource or a failure in the switching mechanism to select the pseudo-translated copy. Advantageously, testing of non-textual resources may be performed simultaneously with translatability testing of text.

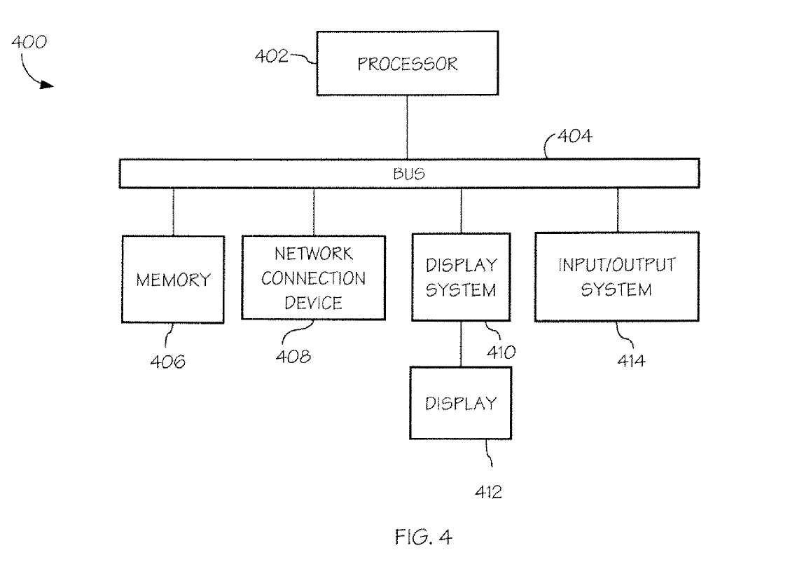

Referring now to FIG. 4, a processing system 400 in accordance with the present invention is shown. Processing system 400 may execute methods 100, 200 of FIGS. 1-2. Processing system 400 may include a processor 402, bus 404, memory 406, network connection device 408, display system 410, display 412, input/output system 414. Bus 404 may connect processor 402 with memory 406, network connection device 408, display system 410 and input/output system 414. It is contemplated that one or more steps of methods 100, 200 of FIGS. 1-2 may be implemented as a program of instructions, or software code, stored in memory 406 for execution by processor 402 for testing translatability of non-textual resources in accordance with an embodiment of the present invention.

It is contemplated that the method and system for testing translatability of non-textual resources in accordance with the present invention may allow resolution of translatability problems at global verification test time. Resolving translatability problems prior to translation, part of a product functional verification test reduces costs and development time. Costs may be further reduced when testing of non-textual resources is coordinated with testing of text.

It is believed that the present invention and many of its attendant advantages will be understood by the foregoing description. It is also believed that it will be apparent that various changes may be made in size, materials, shape, form, function, manner of operation, assembly and use of the components thereof without departing from the scope and spirit of the invention or without sacrificing all of its material advantages. The form herein before described being merely an explanatory embodiment thereof. Further, it is contemplated that the specific order or hierarchy of steps in the method can be rearranged while remaining within the scope and spirit of the present invention. It is the intention of the following claims to encompass and include such changes.

What is claimed is:

1. A method for testing translatability of non-textual resources, comprising:
identifying non-textual resources within an application;
modifying the non-textual resources to create a pseudo-translation copy of each non-textual resource; and
testing said pseudo-translation copy of each non-textual resource, wherein translatability errors within said pseudo-translation copy are detected.

2. The method as claimed in claim 1, wherein non-textual resources are present within a plurality of file formats.

3. The method as claimed in claim 2, wherein said non-textual resources are identified by searching file name extensions associated with said plurality of file formats.

4. The method as claimed in claim 3, wherein said plurality of file formats includes joint photographs expert group (JPEG), waveform audio format (WAV), graphics interchange format (GIF) and bitmap format (BMP).

5. The method as claimed in claim 1, wherein said pseudo-translation copy is placed within a folder associated with a particular language.

6. The method as claimed in claim 1, wherein said pseudo-translation copy is created with a file name which indicates a translated language.

7. The method as clamed in claim 1, wherein said testing of said non-textual resources is performed simultaneously with testing translatability of text.

8. A system for testing translatability of non-textual resources, comprising:
means for identifying non-textual resources within an application;
means for creating a pseudo-translation copy of each non-textual resource; and
means for testing said pseudo-translation copy of each non-textual resource, wherein translatability errors within said pseudo-translation copy are detected.

9. The system as claimed in claim 8, wherein non-textual resources are present within a plurality of file formats.

10. The system as claimed in claim 9, wherein said non-textual resources are identified by searching file name extensions associated with said plurality of file formats.

11. The system as claimed in claim 10, wherein said plurality of file formats includes joint photographs expert group (JPEG), waveform audio format (WAV), graphics interchange format (GIF) and bitmap format (BMP).

12. The system as claimed in claim 8, wherein said pseudo-translation copy is placed within a folder associated with a particular language.

13. The system as claimed in claim 8, wherein said pseudo-translation copy is created with a file name which indicates a translated language.

14. The system as clamed in claim 8, wherein testing of said non-textual resources is performed simultaneously with testing translatability of text.

15. A method for testing translatability of non-textual resources, comprising:
identifying non-textual resources within an application;
creating a pseudo-translation copy of each non-textual resource; and
testing said pseudo-translation copy of each non-textual resource, wherein translatability errors within said pseudo-translation copy are detected.

16. The method as clamed in claim 15, wherein said testing of said non-textual resources is performed simultaneously with testing translatability of text.

17. The method as claimed in claim 15, wherein said pseudo-translated copy has a pseudo indicator.

18. The method as claimed in claim 17, wherein said pseudo indicator is at least one of an audio clip or video clip.

19. The method as claimed in claim 15, wherein said pseudo-translation copy has a modified file name.

20. The method as claimed in claim 19, wherein said modified file name indicates a translated language.
